(19) United States
(12) Patent Application Publication
(10) Pub. No.: US 2026/0193962 A1
(43) Pub. Date: Jul. 9, 2026

(54) SCALE INHIBITOR SQUEEZE TREATMENT SYSTEM AND METHOD OF USING THE SAME

(71) Applicants: Saudi Arabian Oil Company, Dhahran (SA); Halliburton Energy Services, Inc., Houston, TX (US)

(72) Inventors: Zhiwei Yue, Sugar Land, TX (US); Qiwei Wang, Dhahran (SA); Tao Chen, Dhahran (SA)

(21) Appl. No.: 19/013,106

(22) Filed: Jan. 8, 2025

(51) Int. Cl. E21B 37/06; C09K 8/528; E21B 34/08

(52) U.S. Cl. CPC E21B 37/06; C09K 8/528; E21B 34/085; C09K 2208/06

(57) ABSTRACT

A method for treating scale includes feeding a pre-flush fluid into a portion of a subterranean formation via a wellbore. The method includes feeding an inhibitor main pill fluid into the portion of the subterranean formation via the wellbore after the pre-flush fluid, wherein the inhibitor main pill fluid comprises a scale inhibitor. The method includes feeding an overflush fluid into the portion of the subterranean formation via the wellbore after the inhibitor main pill fluid, wherein the overflush fluid comprises one or more surfactant. The method includes shutting in the pre-flush fluid, the inhibitor main pill fluid, and the overflush fluid within the portion of the subterranean formation for a pre-determined period of time.

### TECHNICAL FIELD

Embodiments of the disclosure generally relate to a system and method of removing scale in a wellbore. More specifically, embodiments of this disclosure relate to a scale inhibitor squeeze treatment system and method of using the same.

### BACKGROUND

Whenever an oil or gas well produces water, or water injection is used to enhance recovery, there is a possibility that scale will form on the equipment and wellbore during operation. Common oilfield mineral scales may include calcium carbonate (CaCO₃), calcium sulfate (CaSO₄), barite (BaSO₄), celestite (SrSO₄), gypsum (CaSO₄·H₂O), and iron sulfide (FeS). Less common oilfield mineral scales include calcium fluorite (CaF₂), zinc sulfide (ZnS), and lead sulfide (PbS and PbS₂). Scale formation causes various problems during wellbore production. For example, scale formation decreases the permeability of a subterranean formation, which reduces wellbore productivity, and shortens the lifetime of production equipment.

### SUMMARY

Embodiments of the present disclosure provide a method and system for treating scale in a wellbore and subterranean formation. One technical problem associated with treating scale in water sensitive and/or wellbores with low reservoir pressure (e.g., a low reservoir pressure occurs when the reservoir pressure is below the hydrostatic pressure line), is that the treatment of aqueous fluids may create issues, such as water blockage (e.g., caused by interfacial tension within porous media), water loading (from hydrostatic pressure in the production tubing), and unwanted oil-water emulsions. These various issues can impede hydrocarbon flow and delay the cleanup times (e.g., return of production rate to pre-treatment levels). Embodiments of the present disclosure provide an overflush fluid during a scale inhibitor squeeze (SIS) treatment that may mitigate, or otherwise, prevent the aforementioned technical problems. The provided SIS treatment may include treating a wellbore and subterranean formation with a preflush fluid, an inhibitor main pill fluid, and an overflush fluid. In some embodiments, the overflush fluid comprises a surfactant. The surfactant may be a nonionic surfactant, an amorphous surfactant, or a combination thereof. Incorporating the surfactant into the overflush fluid as described herein offers various technical advantages that address the aforementioned technical problems. For example, the provided overflush fluid may (i) provide a reduction in interfacial tension between water and rock, which plays a role in the recovery of squeeze flush, thereby minimizing operating challenges related to water-blockage and water-loading; (ii) a reduction in interfacial tension between oil, water, and rock, which has the potential to enhance oil production for the well after treatment; and (iii) performance in demulsification of oil-water matrix, lowering flow assurance challenges related to emulsion-blockage in the subterranean formation and/or wellbore tubing.

An embodiment of the present disclosure relates to a method. The method includes providing a pre-flush fluid to a portion of a subterranean formation via a wellbore. After providing the pre-flush fluid, the method includes providing an inhibitor main pill fluid to the portion of the subterranean formation via the wellbore. After providing the inhibitor main pill fluid, the method includes providing an overflush fluid to the portion of the subterranean formation via the wellbore after the inhibitor main pill fluid, where the inhibitor main pill fluid comprises a scale inhibitor and the overflush fluid comprises one or more surfactant.

Another embodiment of the present disclosure relates to a system. The system includes a first vessel comprising a pre-flush fluid. The system includes a second vessel comprising an inhibitor main pill fluid. The system includes a third vessel comprising an overflush fluid, where the overflush fluid comprises one or more surfactant. The system includes a wellbore formed in a subterranean formation, where the wellbore comprises one or more perforations that place crude oil positioned in a portion of the subterranean formation in fluid communication with the wellbore. The system includes at least one pump configured to transport the pre-flush fluid from the first vessel to the wellbore, the inhibitor main pill fluid from the second vessel to the wellbore, and the overflush fluid from the third vessel to the wellbore. The system includes a wellbore valve moveable between an open position that is configured to allow fluid to flow through the wellbore valve and a closed position that is configured to mitigate the flow of the fluid through the wellbore valve. The system includes a controller communicatively coupled to the at least one pump, where the controller includes a memory configured to store instructions that when executed by a processor cause the controller to: (i) provide, using the at least one pump, the pre-flush fluid through the wellbore and to the subterranean formation; (ii) after providing the pre-flush fluid, provide the inhibitor main pill fluid through the wellbore and to the subterranean formation using the at least one pump; (iii) after providing the inhibitor main pill fluid, provide the overflush fluid through the wellbore and to the subterranean formation using the at least one pump; and (iv) close the wellbore valve to shut in the pre-flush fluid, the inhibitor main pill fluid, and the overflush fluid within the subterranean formation for a pre-determined period of time.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF THE DRAWINGS

FIG. 1 is a schematic drawing of a system according to an embodiment of the present disclosure.

FIG. 2 is a schematic drawing of a method for treating scale according to an embodiment of the present disclosure.

FIG. 3 is a graph showing overflush recovery and oil breakthrough (BTT) time for overflush with and without APG surfactant.

Like reference numbers and designations in the various drawings indicate like elements.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

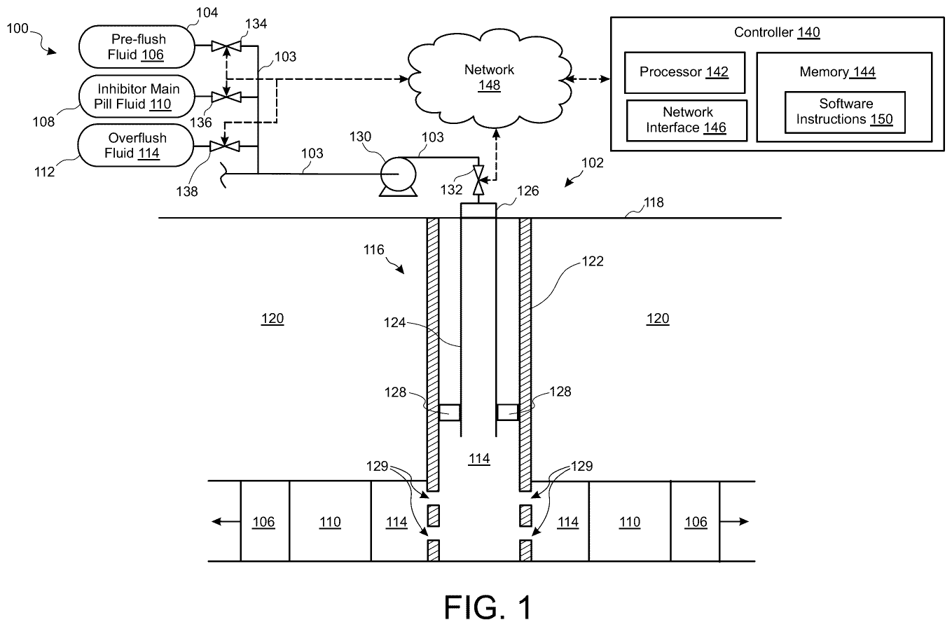

FIG. 1 is a system 100 configured to treat scale at a well site 102 in accordance with embodiments of the present disclosure. In general, the system 100 includes a first vessel 104 comprising a pre-flush fluid 106, a second vessel 108 comprising an inhibitor main pill fluid 110, a third vessel 112 comprising an overflush fluid 114, and a wellbore 116 formed through a surface 118 of the Earth into a subterranean formation 120. The subterranean formation 120 may include an oil reservoir comprising crude oil. In some embodiments, the wellbore 116 includes a wellbore wall 122 that has been drilled to penetrate a portion of the subterranean formation 120, which may be formed out of one or more casing strings disposed therein. The casting strings of the wellbore wall 122 may be a series of connected pipes that are lowered into a wellbore 116 and cemented in place to form the wellbore 116 within the subterranean formation 120. Production tubing 124 may be disposed in the wellbore 116. In some embodiments, a wellbore head 126 is constructed at an entrance to the wellbore 116. The production tubing 124 may be coupled to the wellbore head 126 and configured to extend from the wellbore head 126 to a depth within the wellbore 116. The production tubing 124 may be held in place within the wellbore 116 by one or more packers 128. For example, the packer(s) 128 may be positioned between the wellbore wall 122 and the production tubing 124 to hold the production tubing 124 in place within the wellbore 116. The wellbore wall 122 may include one or more perforations 129 that provide fluid communication between crude oil reserves within the subterranean formation and the wellbore 116.

The system 100 may include one or more pumps 130 that are configured to transfer the pre-flush fluid 106 from the first vessel 104 to the wellbore 116, the inhibitor main pill fluid 110 from the second vessel 108 to the wellbore 116, and the overflush fluid 114 from the third vessel 112 to the wellbore 116. A conduit 103 may place the first vessel 104, the second vessel 108, the third vessel 112, the one or more pumps 130, and the wellbore 116 in fluid communication. The system 100 may include a wellbore valve 132 configured to regulate the flow of fluids between the one or more pumps 130 and the wellbore 116. The wellbore valve 132 may be moveable between an open position that is configured to allow fluid to flow through the wellbore valve 132 to the wellbore 116 and a closed position that is configured to mitigate, or otherwise prevent, the flow of fluid to pass through the wellbore valve 132 to the wellbore 116.

In some embodiments, the system 100 includes a first valve 134 positioned between the first vessel 104 and the one or more pumps 130. The first valve 134 is moveable to an open position that is configured to allow the pre-flush fluid 106 to flow through the first valve 134 to the one or more pumps 130. When the first valve 134 is positioned in the open position, the one or more pumps 130 are configured to transport the pre-flush fluid 106 to the wellbore 116. The first valve 134 is moveable to a closed position that is configured to mitigate, or otherwise prevent, the pre-flush fluid 106 from flowing from the first vessel 104 to the one or more pumps 130.

In some embodiments, the pre-flush fluid 104 comprises a carrier solvent. Suitable carrier solvents for the pre-flush fluid 104 may include, but are not limited to, water, brine, seawater, mutual solvents, or combinations thereof. In some embodiments, potassium chloride (KCl) is present in the pre-flush fluid 104 in an amount from about 0.1 wt. % KCl to about 10 wt. % KCl, based on a total weight of the pre-flush fluid 104. As used herein, the term “mutual solvent” may refer to a solvent that can dissolve in either water or oil. Suitable mutual solvents may include, but are not limited to, glycol ethers (e.g., ethylene glycol monobutyl ether (EGMBE)), alcohols (e.g., methanol, ethanol), ketones (acetone, methyl ethyl ketone), esters (e.g., ethyl acetate). In some embodiments, the mutual solvent is present in an amount from about 10 wt. % to 100 wt. %, based on a total weight of the pre-flush fluid 104.

In general, during a SIS treatment, the pre-flush fluid 106 pushes formation brine within the wellbore 116 into the subterranean formation 120 and can reduce incompatibility issues between forthcoming injected chemicals (e.g., inhibitor main pill fluid 110 and overflush fluid 114) and formation brine. The pre-flush fluid 106 may also cause a cooling effect that may temporarily reduce the adsorption rate of the scale inhibitor in the inhibitor main pill fluid 110, and hence the scale inhibitor can be adsorbed at a further distance within the subterranean formation 120.

In some embodiments, the system 100 includes a second valve 136 positioned between the second vessel 108 and the one or more pumps 130. The second valve 136 is moveable to an open position that is configured to allow the inhibitor main pill fluid 110 to flow through the second valve 136 to the one or more pumps 130. When the second valve 136 is positioned in the open position, the one or more pumps 130 are configured to transport the inhibitor main pill fluid 110 to the wellbore 116. The second valve 136 is moveable to a closed position that is configured to mitigate, or otherwise prevent, the inhibitor main pill fluid 110 from flowing from the second vessel 108 to the one or more pumps 130.

In some embodiments, the inhibitor main pill fluid 110 comprises a carrier solvent. Suitable carrier solvents for the inhibitor main pill fluid 110 may include, but are not limited to, water, brine or seawater. In some embodiments, the carrier solvent is present in an amount from about 75 wt. % to about 99.9 wt. %, based on a total weight of the inhibitor main pill fluid 110. In some embodiments, the inhibitor main pill fluid 110 further comprises a scale inhibitor. In some embodiments, the scale inhibitor is present in an amount from about 0.1 wt. % to about 25 wt. %. Suitable scale inhibitors may include, but are not limited to, phosphonate inhibitors (e.g., nitrilotrimethyl-phosphonic acid (NTMP), diethylenetriamine penta (methylene phosphonic acid) (DTPMP), bis hexamethylene triamine phosphonate (BHPMP)), polyacrylate inhibitors (e.g., phosphino polycarboxylic acid (PPCA)), polyaspartate, amine-containing copolymers, or combinations thereof.

In some embodiments, the system 100 includes a third valve 138 positioned between the third vessel 112 and the one or more pumps 130. The third valve 138 is moveable to an open position that is configured to allow the overflush fluid 114 to flow through the third valve 138 to the one or more pumps 130. When the third valve 138 is positioned in the open position, the one or more pumps 130 are configured to transport the overflush fluid 114 to the wellbore 116. The third valve 138 is moveable to a closed position that is configured to mitigate, or otherwise prevent, the overflush fluid 110 from flowing from the third vessel 112 to the one or more pumps 130.

In some embodiments, the overflush fluid 114 comprises one or more surfactants. In general, any appropriate amount of surfactant may be used. In some embodiments, the total amount of surfactant(s) may be present in an amount from about 0.01 wt. % to about 5 wt. %, based on a total weight of the overflush fluid 114. In some embodiments, the one or more surfactants is present in the overflush fluid in an amount of at least about 0.01 wt. % (e.g., at least about 0.1 wt. %, at least about 0.25 wt. %, or at least about 0.5 wt. %) and/or at most about 5 wt. % (e.g., at most about 0.75 wt. %, at most about 1 wt. %, at most about 2 wt. %, at most about 3 wt. %, or at most about 4 wt. %), based on a total weight of the overflush fluid 114. In some embodiments, the one or more surfactants comprises a nonionic surfactant, an amphoteric surfactant, or a combination thereof. The term “about,” as used in this disclosure, can allow for a degree of variability in a value or range, for example, within 10%, within 5%, or within 1% of a stated value or of a stated limit of a range.

Suitable nonionic surfactants may include, but are not limited to, alkyl polyglycoside, alcohol ethoxylate, nonylphenoxy polyethylenoxy alcohol, poly(ethylene oxide)-poly(propylene oxide) block copolymer, or combinations thereof. In some embodiments, the alkyl polyglycoside has a structure according to the following formula (I):

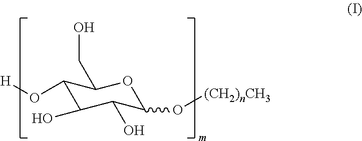

wherein m is an integer that ranges from 1 to 10 and n is an integer that ranges from 1 to 30. In some embodiments m is an integer of at least 1, at least 2, at least 3, to less than 4, less than 5, less than 6, less than 7, less than 8, less than 9, or less than 10. In some embodiments, n is an integer of at least 1, at least 2, at least 3, at least 4, at least 5, to less than 10, less than 11, less than 12, less than 13, less than 14, less than 15, less than 20, less than 25, or less than 30.

In some embodiments, the alcohol ethoxylate has a structure according to the following formula (II):

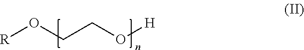

wherein n is an integer that ranges from 1 to 40 and R is an alkyl. As used herein, the term “alkyl” may refer to a straight-chain or branched alkyl radical in all of its isomeric forms, such as straight or branched group. In some embodiments, R is a C₅-C₂₀ alkyl. In some embodiments, n is an integer that ranges from 1 to 40. In some embodiments, n is an integer of at least 1, at least 5, at least 10, to less than 15, less than 20, less than 30 or less than 40.

In some embodiments, the nonylphenoxy polyethylenoxy alcohol has a structure according to the following formula (III):

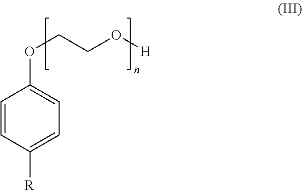

wherein n is an integer that ranges from 1 to 40 and R is a straight or branched C₉ alkyl. In some embodiments, n is an integer of at least 1, at least 5, at least 10, to less than 15, less than 20, less than 30 or less than 40.

In some embodiments, the poly(ethylene oxide)-poly(propylene oxide) block copolymer has a structure according to the following formula (IV):

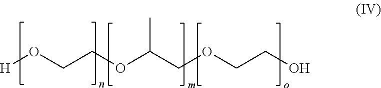

wherein n, m, and o are each independently an integer from 1 to about 150. In some embodiments, n, m, and o are each independently an integer of at least 1, at least about 10, at least about 20, at least about 30, at least about 40, at least about 50, to less than about 60, less than about 70, less than about 80, less than about 90, less than about 100, less than about 110, less than about 120, less than about 130, less than about 140, or less than about 150.

Suitable amphoteric surfactants may include, but are not limited to, alkylamidopropylamine N-oxide, alkyldimethylamine N-oxide, alkylbetaine, alkylamidopropylbetaine, or combinations thereof. In some embodiments, the alkylamidopropylamine N-oxide has a structure according to the following formula (V):

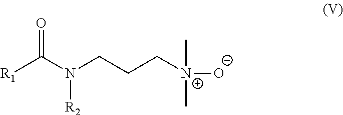

wherein R₁ is a branched or straight chain C₁-C₂₀ alkyl, C₁-C₁₅ alkyl, C₁-C₁₀ alkyl, C₁-C₂₀ alkenyl, C₁-C₁₅ alkenyl, or C₁-C₁₀ alkenyl, and wherein R₂ is hydrogen or branched or straight chain C₁₋₅ alkyl. The term “alkenyl” as used herein refers to an unsaturated straight or branched hydrocarbon having at least one carbon-carbon double bond, such as a straight or branched group of 1-20, 1-15, or 1-10 carbon atoms.

In some embodiments, the alkyldimethylamine N-oxide has a structure according to the following formula (VI):

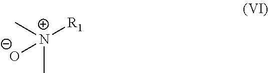

wherein R₁ is a branched or straight chain C₁-C₂₀ alkyl, C₁-C₁₅ alkyl, or C₁-C₁₀ alkyl.

In some embodiments, the alkylbetaine has a structure according to the following formula (VII):

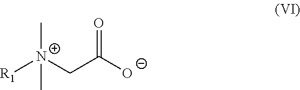

wherein R₁ is a branched or straight chain C₁-C₂₀ alkyl, C₁-C₁₅ alkyl, or C₁-C₁₀ alkyl.

In some embodiments, the alkylamidopropylbetaine has a structure according to the following formula (VII)

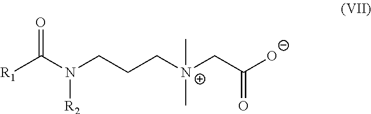

wherein R₁ is a branched or straight chain C₁-C₂₀ alkyl, C₁-C₁₅ alkyl, C₁-C₁₀ alkyl, C₁-C₂₀ alkenyl, C₁-C₁₅ alkenyl, or C₁-C₁₀ alkenyl, and wherein R₂ is hydrogen or branched or straight chain C₁-5 alkyl.

In some embodiments, the overflush fluid 114 comprises an electrolyte, such as potassium chloride (KCl). In some embodiments, the electrolyte is present in the overflush fluid 114 in an amount from about 0.1 wt. % to about 10 wt. %, based on a total weight of the overflush fluid 114. In some embodiments, the electrolyte is present in an amount of at least about 0.1 wt. % (e.g., at least about 1 wt. %, at least about 2 wt. %, at least about 3 wt. %, at least about 4 wt. %, at least about 5 wt. %), and/or at most about 10 wt. % (e.g., at most about 7 wt. %, at most about 8 wt. %, at most about 9 wt. %, or at most about 10 wt. %).

In some embodiments, the overfluish fluid 114 comprises a carrier solvent. In some embodiments, the carrier solvent includes, but is not limited to, water, diesel, or a combination thereof. In some embodiments, the diesel comprises any diesel fuel defined by ASTM D975. In some embodiments, the carrier solvent is present in an amount from about 60 wt. % to about 99.9 wt. %, based on a total weight of the overflush fluid 114. In some embodiments, the carrier solvent is present in an amount of at least about 60 wt. % (e.g., at least about 70 wt. %, at least about 80 wt. %) and/or at most 99.9 wt. % (e.g., at most about 90 wt. %, at most about 95 wt. %, at most about 99 wt. %, or at most 99.9 wt. %).

In some embodiments, the system 100 includes a controller 140. The controller 140 may include a processor 142, a memory 144, and a network interface 146. The system 100 may include a network 148. The network 148 may be any suitable type of wireless and/or wired network, including, but not limited to, all or a portion of an Internet, an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a packet data network (e.g., the Internet), a mobile telephone network (e.g., cellular networks, such as 4G or 5G), a plain old telephone (POT) network, a wireless data network (e.g., WiFi, WiGig, WiMax, etc.), a long-term evolution (LTE) network, a universal mobile telecommunications system (UMTS) network, a peer-to-peer (P2P) network, a Bluetooth network, a near field communication (NFC) network, a Zigbee network, a Z-wave network, a WiFi network, and/or any other suitable network. The network 148 may be configured to support any suitable type of communication protocol.

The network interface 146 is configured to enable wired and/or wireless communications between the controller 140 and various devices in the system 100, such as the one or more pumps 130, the wellbore valve 132, the first valve 134, the second valve 136, and the third valve 138, as well as other components. The network interface 146 may comprise an NFC interface, a Bluetooth interface, a Zigbee interface, a Z-wave interface, a radio-frequency identification (RFID) interface, a WIFI interface, a LAN interface, a WAN interface, a MAN interface, a PAN interface, a WPAN interface, a modem, a switch, and/or a router. The processor 142 may be configured to send and receive data using the network interface 146. The network interface 146 may be configured to use any suitable type of communication protocol.

The memory 144 may be volatile or non-volatile and may comprise read-only memory (ROM), random-access memory (RAM), ternary content-addressable memory (TCAM), dynamic random-access memory (DRAM), and static random access memory (SRAM). The memory 144 may include one or more of a local database, cloud database, network-attached storage (NAS), etc. The memory 144 comprises one or more disks, tape drives, or solid-state drives, and may be used as an over-flow data storage device, to store programs when such programs are selected for execution, and to store instructions and data that are read during program execution. The memory 144 may store any of the information described in FIGS. 1-3 along with any other data, instructions, logic, rules, or code operable to implement the function(s) described herein when executed by processor 142. For example, the memory 144 may store software instructions 150 that when executed by the processor 142 cause the controller 140 to perform the functions described herein.

Processor 142 comprises one or more processors operably coupled to the memory 144. The processor 142 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 142 may be a programmable logic device, a microcontroller, a microprocessor, or any suitable combination of the preceding. The one or more processors 142 are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations. The processor 142 may register the supply operands to the ALU and store the results of ALU operations. The processor 142 may further include a control unit that fetches instructions from memory and executes them by directing the coordinated operations of the ALU, registers and other components. The one or more processors are configured to implement various software instructions. For example, the one or more processors are configured to execute software instructions 150 stored in the memory 144 to perform one or more functions of the controller 140 described herein. In some embodiments, the software instructions 150 include instructions for controlling the first valve 134, the second valve 136, the third valve 138, the one or more pumps 130, and the wellbore valve 132. In this way, processor 142 may be a special-purpose computer designed to implement the functions disclosed herein. In an embodiment, the processor 142 is implemented using logic units, FPGAs, ASICs, DSPs, or any other suitable hardware,

For example, the controller 140 may use the processor 142 to perform an SIS treatment on the wellbore 116. The controller 140 may execute the software instructions 150 using the processor 142 to open the first valve 134, open the wellbore valve 132, and transport the pre-flush fluid 106 from the first vessel 104 using the one or more pumps 130 to the wellbore 116, through perforations 129 in the wellbore 116, and into the subterranean formation 120. Following delivery of the pre-flush fluid 106, the controller 140 may be further configured to close the first valve 134, open the second valve 136, and transport the inhibitor main pill fluid 110 from the second vessel 108 using the one or more pumps 130 to the wellbore 116, through perforations 129 in the wellbore 116, and into the subterranean formation 120. Following delivery of the inhibitor main pill fluid 110, the controller 140 may be further configured to close the second valve 136, open the third valve 138, and transport the overflush fluid 114 from the third vessel 112 using the one or more pumps 130 to the wellbore 116, through perforations 129 in the wellbore 116, and into the subterranean formation 120.

Following the delivery of the overflush fluid 114, the controller 140 is configured to close the wellbore valve 132 to shut in the pre-flush fluid 106, the inhibitor main pill fluid 110, and the overflush fluid 114 within the subterranean formation 120 for a pre-determined period of time. The shut in period allows the scale inhibitor in the inhibitor main pill fluid 110 to reduce an amount of scale in the wellbore 116 (e.g., dissolve the scale) and also adsorb onto rock formations within the subterranean formation 120, which can serve to mitigate further scale formation in the future. In some embodiments the pre-determined period of time may range from 1 minute to 48 hours. In some embodiments, the pre-determined period of time is at least one minute, at least 30 minutes, at least 1 hour, at least 6 hours, at least 12 hours, to less than 24 hours, less than 30 hours, less than 36 hours, less than 42 hours, or less than 48 hours. After the pre-determined period of time has elapsed, the controller 140 is configured to open the wellbore valve 132 to allow produced fluid in the subterranean formation 120 to flow out of the wellbore 116. The produced fluid may include the pre-flush fluid 106, the inhibitor main pill fluid 110, the overflush fluid 114, crude oil and/or water stored in the subterranean formation 120.

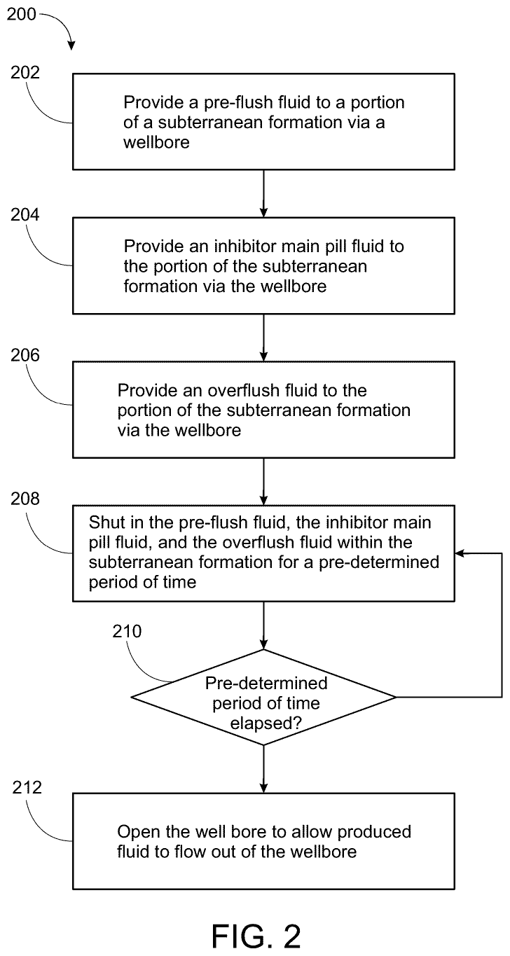

Referring to FIG. 2, a method 200 is provided for treating scale in a subterranean formation 120 according to some embodiments of the present disclosure. The method 200 may begin at operation 202, which includes feeding a pre-flush fluid 106 into a portion of a subterranean formation 120 via a wellbore 116. In some embodiments, operation 202 includes feeding the pre-flush fluid 106 from a first vessel 104, through the conduit 103, and to the wellbore 116 using one or more pumps 130. The one or more pumps 130 may be configured to transport the pre-flush fluid 106 through one or more perforations 129 in the wellbore 116 to the portion of the subterranean formation 120. Operation 202 may include opening a first valve 134 positioned between the first vessel 104 and the one or more pumps 130 and opening a wellbore valve 132 positioned between the one or more pumps 130 and the wellbore 116 to allow the pre-flush fluid 106 to flow into the wellbore 116.

At operation 204, the method 200 includes feeding an inhibitor main pill fluid 110 into the portion of the subterranean formation 120 via the wellbore 116 after the pre-flush fluid 106. In some embodiments, the inhibitor main pill fluid 110 is configured to be fed into the wellbore 116 immediately following the pre-flush fluid 106 such that the inhibitor main pill fluid 110 pushes the pre-flush fluid 106 deeper into the subterranean formation 120. In some embodiments, operation 204 includes feeding the inhibitor main pill fluid 110 from the second vessel 108, through the conduit 103, and to the wellbore 116 using the one or more pumps 130. The one or more pumps 130 may be configured to transport the inhibitor main pill fluid 110 through one or more perforations 129 in the wellbore 116 to the portion of the subterranean formation 120. Operation 202 may include closing the first valve 134 and opening a second valve 136 positioned between the second vessel 108 and the one or more pumps 130 to allow the inhibitor main pill fluid 110 to flow into the wellbore 116.

At operation 206, the method 200 includes feeding an overflush fluid 114 into the portion of the subterranean formation 120 via the wellbore 116 after the inhibitor main pill fluid 110. In some embodiments, the overflush fluid 120 is configured to be fed into the wellbore 116 immediately following the inhibitor main pill fluid 110 such that the overflush fluid 114 pushes the inhibitor main pill fluid 110 and the pre-flush fluid 106 deeper into the subterranean formation 120. The one or more pumps 130 may be configured to transport the overflush fluid 114 through the one or more perforations 129 in the wellbore 116 to the portion of the subterranean formation 120. Operation 206 may include closing the second valve 136 and opening the third valve 138 positioned between the third vessel 112 and the one or more pumps 130 to allow the overflush fluid to flow into the wellbore 116.

At operation 208, the method 200 includes shutting in the pre-flush fluid 104, the inhibitor main pill fluid 110, and the overflush fluid 114 within the portion of the subterranean formation 120 for a pre-determined period of time. Operation 208 may include closing the wellbore valve 132 to shut in the pre-flush fluid 104, the inhibitor main pill fluid 110, and the overflush fluid 114 within the portion of the subterranean formation 120. In some embodiments, the pre-determined period of time is at least 1 minute, at least 30 minutes, at least 1 hour, at least 6 hours, at least 12 hours, to less than 24 hours, less than 30 hours, less than 36 hours, less than 42 hours, or less than 48 hours.

At decision block 210, the method 200 includes determining whether the pre-determined period of time has elapsed. If the pre-determined period of time has not elapsed, the method 200 returns to operation 208. If the pre-determined period of time has elapsed, the method proceeds to operation 212. At operation 212, the method 200 includes opening the wellbore valve 132 to allow produced fluid in the subterranean formation 120 to flow out of the wellbore 116. The produced fluid may include the pre-flush fluid 106, the inhibitor main pill fluid 110, the overflush fluid 114, crude oil and/or water stored in the subterranean formation 120.

### EXAMPLES

### Example 1-Scale Inhibitor Squeeze (SIS) Treatment

A glass cylinder was packed with 90% sand and 10% washed formation rock cuttings, both in 80/100 mesh size. The packing column was treated with either 8% KCl which represented the overflush treatment to the squeezed formation using a control SIS overflush, or the same KCl solution containing 1000 ppm (0.1%) alkyl polyglycoside (APG) surfactant. The 10-mL overhead crude oil applied a constant head pressure of 0.1-0.2 psi to simulate the recovery process of the treatment fluid and production of hydrocarbon through the treated formation zone, especially for reservoirs with low or depleted pressures. In general, the faster and more percentage recovery of the treating fluid and the earlier the breakthrough time (BTT) for the crude, the less water-blockage or water-loading risk is expected for the wells to be squeezed.

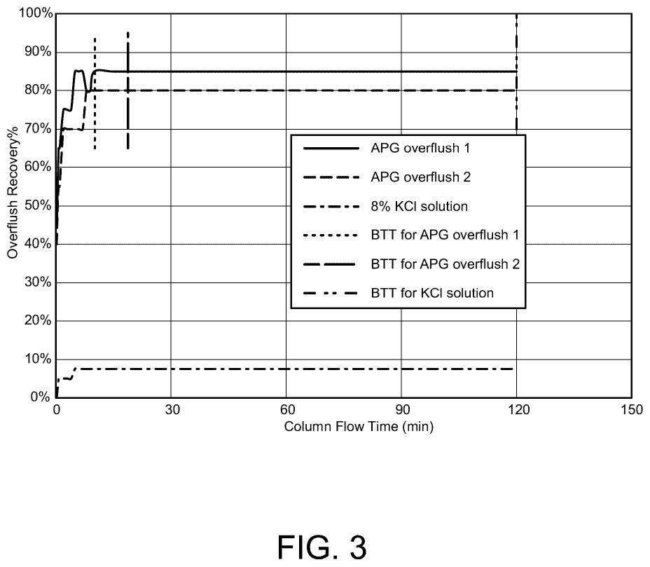

Experimental results are listed in FIG. 3. In the experiments, the control squeeze overflush fluid (8% KCl solution) failed to penetrate the treated formation column under the applied low pressure, mimicking the operational challenges encountered in recovering the SIS squeeze treating fluids. The breakthrough time (BTT) exceeded 120 minutes (the end of the experimental testing window), with an overflush recovery rate of only about 8%. In contrast, when treated with the innovative APG-containing overflush, duplicate tests (e.g., “APG overflush 1” and “APG overflush 2”) yielded BTT values of 10.2 and 18.8 minutes, respectively. The recovery rate for the APG overflush 1 reached 85% at approximately 5 minutes and the recovery rate for the APG overflush 2 reached approximately 80% within 5 to 8 minutes and plateauing thereafter. The APG surfactant can also assist in demulsifying unwanted oil/water emulsions. The BTT was recorded by instant tracking the crude front breakthrough in the packed columns, whereas the recovery rate was measured for the volume of the collected fluid after it passed through the columns and flowed out of the funnel into the collective vessel. There was delay between the turning points of the flush percentage curves and the BTT time.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A method comprising:
providing a pre-flush fluid to a portion of a subterranean formation via a wellbore;
after providing the pre-flush fluid, providing an inhibitor main pill fluid to the portion of the subterranean formation via the wellbore, wherein the inhibitor main pill fluid comprises a scale inhibitor; and
after providing the inhibitor main pill fluid, providing an overflush fluid to the portion of the subterranean formation via the wellbore after the inhibitor main pill fluid,
wherein the overflush fluid comprises:
one or more surfactant; and
from about 5 wt. % to about 10 wt. % of an electrolyte, based on a total weight of the overflush fluid.

2. The method of claim 1 further comprising:
after providing the overflush fluid, shutting in the pre-flush fluid, the inhibitor main pill fluid, and the overflush fluid within the portion of the subterranean formation for a pre-determined period of time; and
wherein after the pre-determined period of time has elapsed, opening a wellbore valve to allow produced fluid in the subterranean formation to flow out of the wellbore.

3. The method of claim 1, wherein the surfactant is present in the overflush fluid in an amount from about 0.01 wt. % to about 5 wt. %, based on a total weight of the overflush fluid.

4. The method of claim 1, wherein the surfactant comprises a nonionic surfactant.

5. The method of claim 4, wherein the nonionic surfactant comprises at least one member selected from the group consisting of alkyl polyglycoside, alcohol ethoxylate, nonylphenoxy polyethylenoxy alcohol, and poly(ethylene oxide)-poly(propylene oxide) block copolymer.

6. The method of claim 1, wherein the surfactant comprises an amphoteric surfactant.

7. The method of claim 6, wherein the amphoteric surfactant comprises at least one member selected from the group consisting of alkylamidopropylamine N-oxide, alkyldimethylamine N-oxide, alkylbetaine, and alkylamidopropylbetaine.

8. (canceled)

9. The method of claim 1, wherein the electrolyte comprises potassium chloride.

10. The method of claim 1, wherein the overflush fluid further comprises a carrier solvent, wherein the carrier solvent is present in an amount from about 60 wt. % to about 99.9 wt. %, based on a total weight of the overflush fluid.

11. The method of claim 10, wherein the carrier solvent is selected from the group consisting of water, diesel, or combinations thereof.

12. The method of claim 1,
wherein the overflush fluid further comprises a carrier solvent, wherein the carrier solvent is present in an amount from about 60 wt. % to about 99.9 wt. %, based on the total weight of the overflush fluid; and
wherein the surfactant is a nonionic surfactant, and wherein the nonionic surfactant is present in the overflush fluid in an amount from about 0.01 wt. % to about 0.75 wt. %, based on the total weight of the overflush fluid.

13. The method of claim 1, wherein the overflush fluid further comprises an electrolyte, wherein the electrolyte is present in the overflush fluid in an amount from about 0.1 wt. % to about 10 wt. %, based on a total weight of the overflush fluid;
wherein the overflush fluid further comprises a carrier solvent, wherein the carrier solvent is present in an amount from about 60 wt. % to about 99.9 wt. %, based on the total weight of the overflush fluid; and
wherein the surfactant is an amphoteric surfactant, and wherein the amphoteric surfactant is present in the overflush fluid in an amount from about 0.01 wt. % to about 5 wt. %, based on the total weight of the overflush fluid.

14. A system comprising:
a first vessel comprising a pre-flush fluid;
a second vessel comprising an inhibitor main pill fluid;
a third vessel comprising an overflush fluid, wherein the overflush fluid comprises one or more surfactant and from about 5 wt. % to about 10 wt. % of an electrolyte, based on a total weight of the overflush fluid;
a wellbore formed in a subterranean formation, wherein the wellbore comprises one or more perforations that place crude oil positioned in a portion of the subterranean formation in fluid communication with the wellbore;
at least one pump configured to transport the pre-flush fluid from the first vessel to the wellbore, the inhibitor main pill fluid from the second vessel to the wellbore, and the overflush fluid from the third vessel to the wellbore;
a wellbore valve moveable between an open position that is configured to allow fluid to flow through the wellbore valve and a closed position that is configured to mitigate the flow of the fluid through the wellbore valve; and
a controller communicatively coupled to the at least one pump, the controller including a memory configured to store instructions that when executed by a processor cause the controller to:
provide, using the at least one pump, the pre-flush fluid through the wellbore and to the subterranean formation;
after providing the pre-flush fluid, provide the inhibitor main pill fluid through the wellbore and to the subterranean formation using the at least one pump; and
after providing the inhibitor main pill fluid, provide the overflush fluid through the wellbore and to the subterranean formation using the at least one pump; and
close the wellbore valve to shut in the pre-flush fluid, the inhibitor main pill fluid, and the overflush fluid within the subterranean formation for a pre-determined period of time.

15. The system of claim 14, wherein the controller is further configured to:
after providing the overflush fluid, close the wellbore valve to shut in the pre-flush fluid, the inhibitor main pill fluid, and the overflush fluid within the subterranean formation for a pre-determined period of time; and
wherein after the pre-determined period of time has elapsed, open the wellbore valve to allow produced fluid in the subterranean formation to flow out of the wellbore.

16. The system of claim 14, wherein the surfactant is present in the overflush fluid in an amount from about 0.01 wt. % to about 5 wt. %, based on a total weight of the overflush fluid.

17. The system of claim 14, wherein the surfactant comprises a nonionic surfactant.

18. The system of claim 14, wherein the nonionic surfactant comprises at least one member selected from the group consisting of alkyl polyglycoside, alcohol ethoxylate, nonylphenoxy polyethylenoxy alcohol, and poly(ethylene oxide)-poly(propylene oxide) block copolymer.

19. The system of claim 14, wherein the surfactant comprises an amphoteric surfactant.

20. The system of claim 14, wherein the amphoteric surfactant comprises at least one member selected from the group consisting of alkylamidopropylamine N-oxide, alkyldimethylamine N-oxide, alkylbetaine, and alkylamidopropylbetaine.

21. The method of claim 1, wherein the one or more surfactant comprises alkyl polyglycoside, wherein the alkyl polyglycoside has a structure according to formula (I): 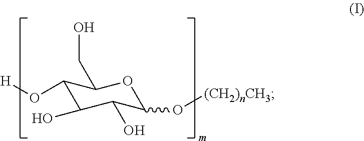
wherein m is an integer from 2 to 10 and n is an integer from 4 to 30.
